(19) United States
(12) Patent Application Publication
(10) Pub. No.: US 2012/0280153 A1
(43) Pub. Date: Nov. 8, 2012

(54) VALVE WITH AT LEAST ONE CLOSING BODY

(75) Inventors: Erwin Dunser, Frastanz (AT); Markus Lindner, Nenzing (AT); Peter Zvokelj, Hochst (AT)

(73) Assignee: VAT HOLDING AG, Haag (CH)

(21) Appl. No.: 13/461,865

(22) Filed: May 2, 2012

(30) Foreign Application Priority Data
May 2, 2011 (DE) 102011100218.2

(51) Int. Cl. F16K 31/122

(52) U.S. Cl. 251/63.6

(57) ABSTRACT

A valve, particularly a vacuum valve, with at least one closing body to close at least one penetrating opening of the valve and a drive to adjust the closing body between a closed position, in which the closing body closes the penetrating opening, and at least one opened position, in which the closing body at least partially releases the penetrating opening. The drive includes a first volume, which can be impinged with pressure, to adjust the closing body into its closed position and for adjusting it to an opened position, with the valve additionally having an elastic element, which pre-stresses the closing body in a direction of its closed position or its opened position.

### CROSS-REFERENCE TO RELATED APPLICATIONS

This application claims the benefit of German Patent Application No. 10 2011 100 218.2, filed May 2, 2011, which is incorporated herein by reference as if fully set forth.

### BACKGROUND

The present invention relates to a valve, particularly a vacuum valve, with at least one valve body to close at least one penetrating opening of the valve and a drive for adjusting the closing body between a closed position, in which the closing body closes the penetrating opening, and at least one opened position, in which the closing body at least partially releases the penetrating opening, with the drive comprising a first volume, which can be impinged with pressure, to adjust the closing body in its closed position and at least another volume, which can be impinged with pressure, to adjust the closing body in its opened position.

Valves, particularly for vacuum technology, are known from prior art in numerous embodiments. The same applies for types of drives.

In generic valves the first volume is pressurized, when the drive of the closing body is to be brought into the closed position. The other volume is pressurized in order to move the closing body back in the opposite direction into its opened position. In prior art it is known to use dually operating cylinders for such drives. One such generic prior art is shown, e.g., in U.S. Pat. No. 6,367,770 B1. In these generic valves the status is problematic, though, when the drive is without any pressure. In this state, the closing body has no defined position.

### SUMMARY

The objective of the present invention is to improve generic valves of this type such that the closing body also assumes a defined position in the unpressurized state of the drive.

According to the invention, here it is provided that the valve additionally comprises an elastic element, which pre-stresses the closing body in the direction of its closed position or its opened position.

One fundamental idea of the invention is therefore in addition to the drive to provide an elastic element, which pre-stresses the closing body in the direction towards its closed position or in the direction of its opened position. In this way it is possible that the elastic element of the closing body in the unpressurized state of the drive is also pressed at least to a seat of the valve or into an opened resting position. It may be provided that the elastic element of the closing body is permanently pre-stressed in the direction of the opened position.

Particularly preferred, the valves according to the invention represent so-called vacuum valves, which can be used in vacuum technology. In vacuum technology, sensitive components, such as semiconductor elements and the like, are processed under clean-room conditions in vacuum chambers. The vacuum valves serve as the connection between such vacuum chambers or to control media entering and evacuating the vacuum chambers. Vacuum technology is defined as vacuum chambers showing pressures below 0.001 millibar and/or 0.1 Pascal in the operating state, in which the respective vacuum is applied.

The drives of such valves according to the invention are beneficially pneumatic, particularly in vacuum technology. This means, pressures and vacuums in the volumes of the drive are generated by injecting and evacuating gaseous media. However, valves with hydraulic drives are possible just as well according to the invention, in which liquids and particularly oils can be used as pressurizing media.

The term volumes used in this application could also be replaced by the term chambers. Ultimately, volumes represent chambers with pressurization being possible in their interior space. For this purpose, of course the chambers and/or volumes must be equipped with unspecified, but appropriately designed walls, and perhaps respective blocking possibilities as well as connectors for respective pressure sources and connections for releasing pressures. This is known in prior art, though. In this context, preferred embodiments provide that the drive shows a dually operating cylinder or is comprised thereof, with the first volume, which can be impinged with pressure, and the other volume, which can be impinged with pressure, each representing pressure chambers of the cylinder and at least one displaceable piston is arranged between the pressure chambers, displaceable via a pressure difference in said pressure chambers.

Due to the fact that the elastic element provided in addition to the drive is primarily provided to ensure a defined position of the closing body in the unpressurized state of the drive it is beneficial when via the elastic element only comparatively weak forces are applied upon the closing bodies. This avoids that the drive for adjusting the closing body requires unnecessarily amounts of energy in its opened position or its closed position. When the elastic element acts in the direction of the closed position it is beneficial in this context that in the closed position of the closing body a seal is arranged between the closing body and the seat of the valve and the pressure force applied in the closed position by the elastic element upon the seal ranges from 0.1 to 0.5, preferably from 0.1 to 0.2 Newton per millimeter of length of the seal. In this embodiment, the forces applied by the elastic element are sufficient in the unpressurized state of the drive to cause the closing body with its seal to contact the seat. Here, any sealing effect and thus the absence of a pressure difference between the chambers connected via penetrating openings and/or lines is not yet achieved. When the elastic element is designed such that in absence of the above-mentioned pressure difference and in the unpressurized state of the drive the closing body presses against the seat in a sealing fashion it is beneficial for a seal to be arranged in the closed position of the sealing body between the closing body and the seat of the valve and the pressure force acting in the closed state by the elastic element upon the seal ranges from 1 to 5, preferably from 1 to 2 Newton per millimeter of length of the seal.

There are various options for the structural embodiment of the elastic element. The elastic element may represent a tensile spring or a pressure spring. The elastic element may in both variants, e.g., represent a coil spring or a flat spring or a gas-pressure spring or an air spring or an elastomer-body or comprise such components. Combinations thereof are also possible.

The elastic element may also be called the initial spring. The term initial spring indicates that the elastic element essentially serves to ensure a defined position of the closing body in the unpressurized state.

### BRIEF DESCRIPTION OF THE DRAWINGS

Further embodiments and details of the present invention are discernible from the following description of the preferred embodiments. Shown are:

FIG. 1 is a schematic longitudinal cross-section of a first embodiment according to the invention;

FIG. 2 is a respective longitudinal cross-section through a second embodiment according to the invention,

FIG. 3 is a respective longitudinal cross-section through a third embodiment according to the invention;

FIG. 4 is a longitudinal cross-section through a fourth valve according to the invention, and

FIG. 5 is a longitudinal cross-section through a fifth exemplary embodiment of the invention, in which, contrary to the first four exemplary embodiments, the elastic element pre-stresses the closing body in the opened position.

### DETAILED DESCRIPTION OF THE PREFERRED EMBODIMENTS

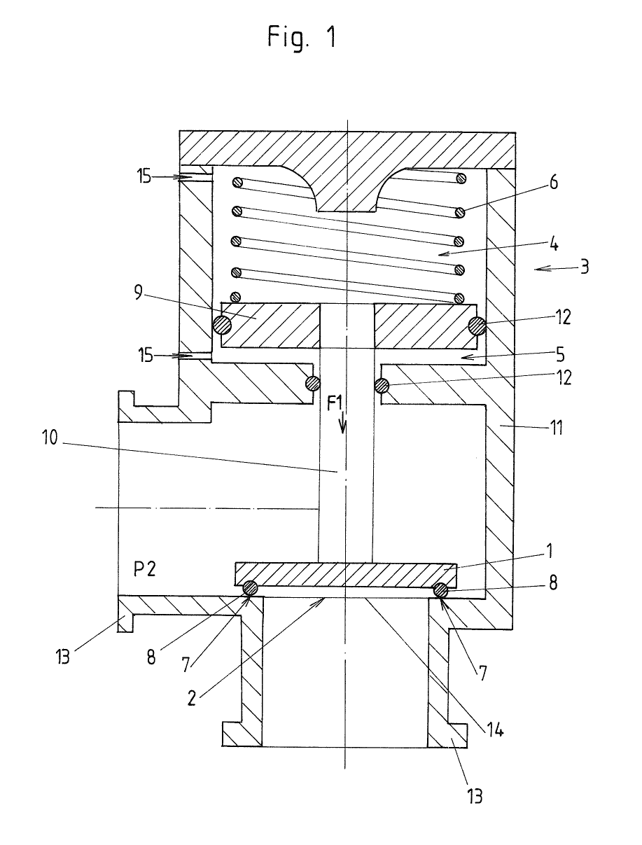

The first variant of the embodiment according to FIG. 1 represents a so-called angle valve. However, this is not mandatory, here.

The lines leading to and from the valve shown are connected to the assembly flange 13 of the housing 11. The penetrating opening 2 is closed by the closing body 1, which is here embodied as a valve plate. In the closed position, as shown in FIG. 1, the seal 8 seals the closing body 1 from the seat 7. The elastic element 6 according to the invention, here embodied as a coil spring, ensures that the closing body 1 assumes a defined position in the unpressurized state of the drive 3, in which it contacts the seat 7 via the seal 8. Here, it is sufficient for the elastic element 6 to apply relatively minor forces upon the closing body 1. With regards to the seal 8 it is beneficially provided that the pressure force applied by the elastic element 6 upon the seal 8 ranges from 0.1 to 0.5, preferably from 0.1 to 0.2 Newton per millimeter of length of the seal 8.

If in case of a situation with an unpressurized drive 3 and without any pressure difference in the line leading to and from the valve, sealing is to be achieved via the elastic element 6, it is beneficially provided that the pressure force applied by the elastic element 6 upon the seal 8 ranges from 1 to 5, preferably from 1 to 2 Newton per millimeter of length of the seal 8.

In order to open the penetrating opening 2, the closing body 1 is lifted via the drive 3 from the seat 7. For this purpose, pressure medium, e.g., a respective gas, is injected via the connection 15 into the volume 5. The first volume 4 is respectively evacuated via the connection 15. By an appropriate pressure developing here upon the piston 9, based on the closed position according to FIG. 1, the closing body 1 is lifted off the seat 7 and brought into its opened position. The extent of the stroke can be controlled via the pressure ratios in the two volumes 4 and 5. In order to close the valve, i.e. to move the closing body 1 into its closed position according to FIG. 1, a respective pressure medium is introduced into the first volume 4, while the second volume 5 is accordingly evacuated. The pressures to be applied for the above-mentioned processes upon the connections 15 and thus the volumes 4 and 5 may range, e.g., from 2.5 bar to 8 bar, preferably from 4 bar to 7 bar. The pressure force applied by the drive 3 in the closed position upon the seal 8 amounts in this or any other exemplary embodiment beneficially at least 4-fold the pressure force applied by the elastic element 6. This factor increases with higher nominal values and/or diameters 14 of the penetrating opening 2 of the valve.

In the sense of a simple design, according to FIG. 1, the elastic element 6 beneficially impacts the closing body 1 via the piston rod 10. In the exemplary embodiment of a drive 3 shown in the form of a dual acting cylinder it is beneficially provided that the piston 9 is connected via the piston rod 10 to the closing body 1, with a space formed between the piston 9 and the closing body 1 in the area of the piston rod 10 in a fixed and/or unchangeable fashion. The closing body 1 can be fixed stiffly to the piston rod 10. The closing body 1 may also be fastened in an articulate and/or pivotal fashion to the piston rod 10, in the sense of an optimal sealing.

It is not necessary that this relates to a dual operating cylinder. The two volumes 4 and 5 may e.g., also be separated from each other by appropriate diaphragms arranged therebetween, with the deflection of the diaphragm being transferred via suitable measures, such as a piston rod 5, to the closing body 1.

For reasons of completeness, additional seals 12 shall be mentioned, which on the one side seal the piston rod 10 from the housing 11 and on the other side the piston 9 from the housing 11.

In the first exemplary embodiment shown according to FIG. 1 the elastic element 6 is arranged inside at least one of the volumes 4 and 5 impinged with pressure. In the variant shown according to FIG. 1 this represents the volume 4, which serves to move the closing body 1 into the closed position. In particular in such embodiments in which the elastic element 6 is arranged inside at least one of the volumes 4 and 5 it is beneficial for the elastic element 6 to directly affect the piston.

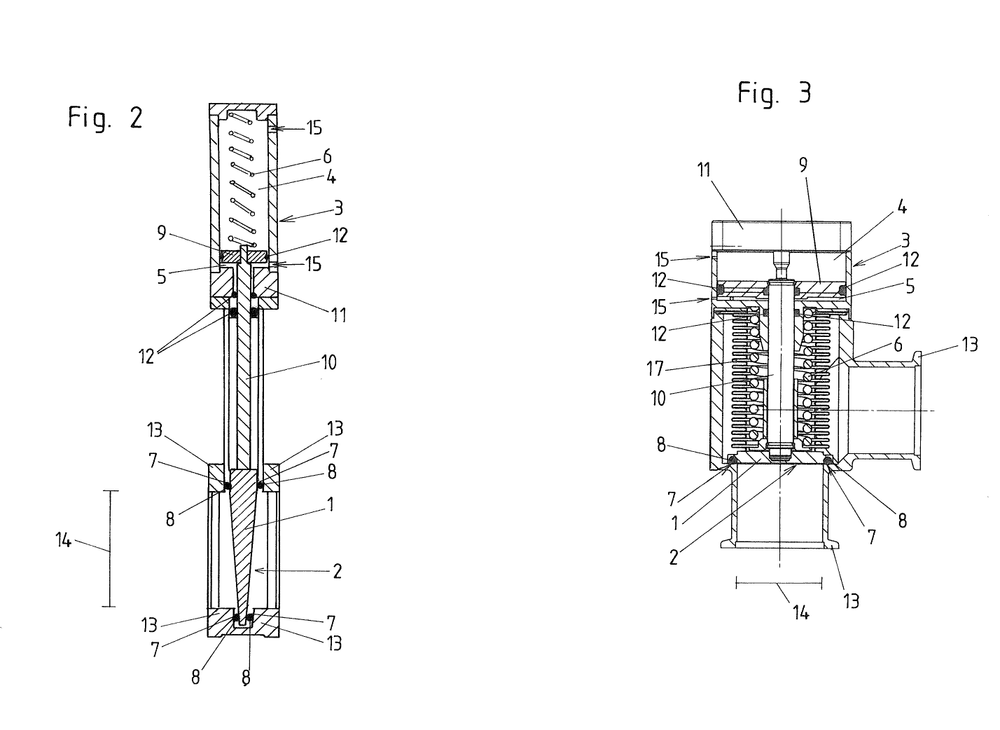

FIG. 2 shows another exemplary embodiment of the invention. Here, the valve not an angle valve but is embodied as a slider. Instead of the valve plate according to FIG. 1, a wedge-shaped closing body 1 is provided. It also seals the penetrating opening 2 arranged between the assembly flanges 13. Such wedge-shaped closing bodies 1 are known per se, and thus no longer need to be explained. In any case, in the exemplary embodiment the closing body 1 is brought from the closed position shown in FIG. 2 into the opened position, not shown here, by lifting the piston rod 10. Once more, the drive 3 is provided for opening and closing. Similar to the first exemplary embodiment, this represents a dual acting cylinder, so that this requires no repeated explanation. In the second exemplary embodiment the elastic element 6 is arranged in one of the volumes 4 of the drive 3.

The fact that this is not mandatory is shown in the following exemplary embodiments. FIG. 3 shows a third variant of the invention, once more representing an angle valve. In this variant it is provided that the elastic element is arranged at the side facing the closing body 1, outside the volumes 4 and 5 that can be impinged with pressure. Here, too, the elastic element 6 serves as an initial spring, which in the unpressurized state of the drive 3 presses the closing body 1, embodied here too as a valve plate, with its seal 8 against the seat 7. In the exemplary embodiment shown, an elastic bellows 17 is arranged around the elastic element 6, once more embodied as a helical spring, which is compressed and/or stretched according to the motion of the closing body 1. The drive 3 operates similar to those described in the other embodiments and thus requires no detailed explanation, here. The same applies for all other details of this third exemplary embodiment, not mentioned here.

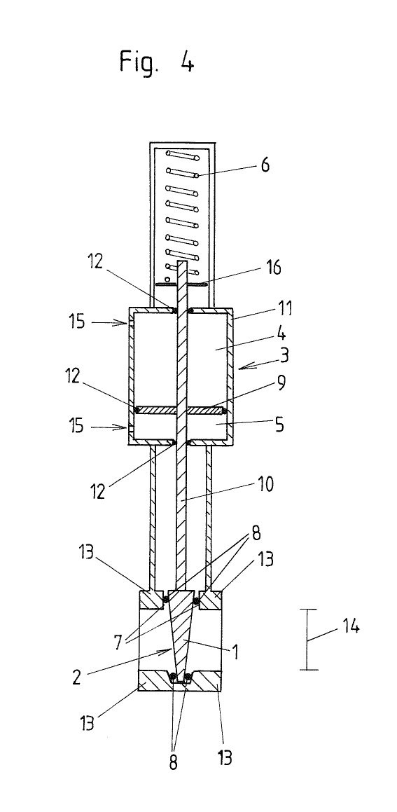

FIG. 4 shows a fourth variant of an embodiment according to the invention. The valve shown here once more represents a slider with a wedge-shaped closing body 1. Contrary to the other already described embodiment variants, here the elastic element 6 is arranged on the side of the volumes 4 and 5 facing away from the closing body 1 that can be impinged with pressure. The elastic element 6 serving as the initial spring in the form of a helical spring is supported on a respective supporting shoulder 16 of the piston rod 10. The functionality of the valve and its design are otherwise discernible from the explanations of the previously shown exemplary embodiments.

Valves according to the invention are beneficially used when the objective is to allow opening and closing relatively large penetrating openings 2. In the valves according to the invention exhibiting circular penetrating openings the diameter 14 of this penetrating opening 2 may show a nominal value of 200 mm and more. If the penetrating opening 2 does not have a circular cross-section, the same applies for the area of the penetrating opening 2 resulting from this diameter.

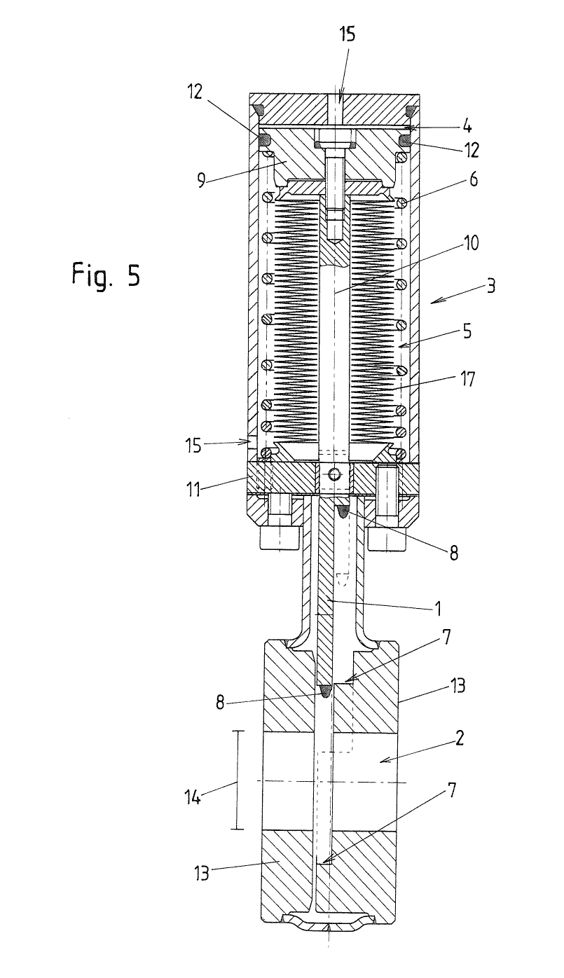

In the first four exemplary embodiments the elastic element 6 pre-stresses the closing body 1 in the direction of the closed position. In the fifth exemplary embodiment according to FIG. 5 the elastic element 6 is provided for the purpose to pre-stress the closing body 1 in the direction of its opened position.

The two volumes 4 and 5 of the drive 3 are also alternating between pressurized and evacuated state via the respective connections 15 in order to move the closing body 1, here a slider, from the opened position shown into the closed position and vice versa. The elastic element 6, also embodied as a helical spring, brings the closing body 1 into the opened position shown when the drive 3 is unpressurized, thus when no pressure exists in any of the volumes 4 or 5 in reference to the respectively other volume. All other features of this exemplary embodiment are self explanatory or discernible from the above-described variants according to the invention.

### LEGEND FOR THE REFERENCE CHARACTERS

1 Closing body

2 Penetrating opening

3 Drive

4 First volume

5 Additional volume

6 Elastic element

7 Seat

8 Seal

9 Piston

10 Piston rod

11 Housing

12 Seal

13 Assembly flange

14 Diameter

15 Connection

16 Support shoulder

17 Bellows

1. A valve, comprising at least one closing body (1) to close at least one penetrating opening (2) of the valve and a drive (3) to adjust the closing body (1) between a closed position, in which the closing body (1) closes the penetrating opening (2), and at least one opened position, in which the closing body (1) at least partially releases the penetrating opening (2), the drive (3) comprising a first volume (4), which can be pressurized, to adjust the closing body (1) into the closed position and at least another volume (5), which can be pressurized, to adjust the closing body (1) into the opened position, wherein the valve comprises in addition an elastic element (6) which acts on the closing body (1) pre-stressing it in a direction of the closed position or the opened position.

2. A valve according to claim 1, wherein the elastic element (6) also pre-stresses the closing body (1) in the unpressurized state of the drive (3).

3. A valve according to claim 2, wherein the elastic element (6) pre-stresses the closing body (1) into at least one seat (7) of the valve.

4. A valve according to claim 1, wherein the closing body (1) is permanently pre-stressed in the direction of the closed position or the opened position.

5. A valve according to claim 1, wherein a seal (8) is arranged in the closed position of the closing body (1) between the closing body (1) and a seat (7) of the valve and pressure applied in the closed position by the elastic element (6) upon the seal (8) ranges from 0.1 to 0.5 Newton per millimeter of length of the seal (8).

6. A valve according to claim 1, wherein in the closed position of the closing body (1) a seal (8) is arranged between the closing body (12) and a seat (7) of the valve and a pressure force applied in the closed position by the elastic element (6) upon the seal (8) ranges from 1 to 5 Newtons per millimeter of length of the seal (8).

7. A valve according to claim 1, wherein the elastic element (6) comprises at least one of a pressure spring, a tensile spring, a coil spring, a flat spring, a gas-pressure spring, an air spring, or an elastomer body.

8. A valve according to claim 1, wherein the drive (3) comprises a dual operating cylinder, with the first volume (4), which can be pressurized, and the other volume (5), which can be pressurized, each being formed by pressure chambers of the cylinder and at least one piston (9) is arranged between the pressure chambers, which is displaceable by a pressure difference in the pressure chambers.

9. A valve according to claim 8, wherein the piston (9) is connected via a piston rod (10) to the closing body (1), with a space between the piston (9) and the closing body (1) being formed, that is at least one of fixed or unchangeable in an area of the piston rod (10).

10. A valve according to claim 9, wherein the closing body (1) is fastened stiffly to the piston rod (10).

11. A valve according to claim 9, wherein the closing body (1) is fastened to the piston rod (10) in at least one of an articulate or pivotal fashion.

12. A valve according to claim 9, characterized in that the elastic element (6) acts via the piston rod (10) upon the closing body (1).

13. A valve according to claim 1, wherein the elastic element (6) is arranged inside of at least one of the volumes (4, 5) which can be impinged with pressure.

14. A valve according to claim 13, wherein the elastic element (6) acts directly upon the piston (9).

15. A valve according to claim 1, wherein the elastic element (6) is arranged outside the volumes (4, 5), which can be pressurized, at a side facing the closing body (1) or facing away from the closing body (1).

16. A valve according to claim 1, wherein the valve is a vacuum valve.
